(19) United States
(12) Patent Application Publication
(10) Pub. No.: US 2014/0156804 A1
(43) Pub. Date: Jun. 5, 2014

(54) INFORMATION PROCESSING SYSTEM AND METHOD THEREOF

(71) Applicants: INVENTEC (PUDONG) TECHNOLOGY CORPORATION, Shanghai (CN); INVENTEC CORPORATION, Taipei (TW)

(72) Inventor: Sean LIU, Shanghai (CN)

(73) Assignees: INVENTEC CORPORATION, Taipei (TW); INVENTEC (PUDONG) TECHNOLOGY CORPORATION, Shanghai (CN)

(21) Appl. No.: 13/832,046

(22) Filed: Mar. 15, 2013

(30) Foreign Application Priority Data
Nov. 30, 2012 (CN) 201210507476.5

(51) Int. Cl. H04L 12/26

(52) U.S. Cl. CPC H04L 43/08
USPC 709/219

(57) ABSTRACT

An information processing system and a method thereof are provided. When monitoring that a network connecting speed between a main server and a client is too low, an assist server monitors all packets transmitted between the main server and the client, and after finding a packet that meets a takeover condition, the assist server requests, in replacement of the client, the main server to process the packet and finally returns a computing processing result fed back by the main server to the client. The above technical means achieves the technical efficacy of proactively assisting the main server to reduce the loading thereof.

### BACKGROUND OF THE INVENTION

1. Field of the Invention

The present invention relates to an information processing system and a method thereof, and more particularly to an information processing system and a method thereof in which an assistant takes over a client packet and requests, in replacement of a client, a main server to process the packet when a network connecting speed between the main server and the client is too low.

2. Description of Related Art

Cloud computing is a computing technology established based on the Internet. Through this technology, software and hardware resources and data shared on the Internet may be provided to a most appropriate computer and device.

Generally speaking, a cloud computing service can provide better use experience in a network with a fast enough transmission speed. When the network connecting speed is too low, performance of the cloud computing service is poor. As a result, most functions in the cloud computing service cannot be used normally.

However, the network connecting speed of the network is not only restricted by a network environment of the client, but also restricted by a network environment of a server that provides the cloud computing service. Even if a bandwidth of the client is great enough, the server may still have excessive loading if a network connecting speed of the server is too low, thereby affecting the server in processing a request from the client.

To sum up, for a long time, the prior art has the following problem: a main server is incapable of effectively processing a request from a client due to excessive loading when a network connecting speed is too low, so it is necessary to provide an improved technical means to solve this problem.

### SUMMARY OF THE INVENTION

In view of the problem in the prior art that a main server is incapable of effectively processing a request from a client due to excessive loading when a network connecting speed is too low, the present invention discloses an information processing system and a method thereof.

The information processing system disclosed in the present invention includes: a main server, providing a client connection and used for receiving a request and obtaining a computing processing result, and an assist server. The assist server further includes: a packet monitoring module, used for monitoring a network connecting speed between the main server and the client, and when the network connecting speed is lower than a predetermined network speed value, monitoring all packets transmitted between the main server and the client; a condition determination module, used for searching for and acquiring a packet that meets a takeover condition; a packet interception module, used for communicating with the main server and sending, in replacement of the client, a processing request for the packet that meets the takeover condition to the main server; and a processing module, used for receiving the computing processing result fed back by the main server and sending the computing processing result to the client.

The information processing method disclosed in the present invention is applied to a server environment. The server environment at least includes: a main server and an assist server. The main server provides at least one client connection. The method at least includes: monitoring a network connecting speed between the main server and the client by the assist server; monitoring by the assist server all packets transmitted between the main server and the client when the network connecting speed is lower than a predetermined network speed value; searching for and acquiring by the assist server a packet that meets a takeover condition from the packets; communicating with the main server and sending a processing request for the packet that meets the takeover condition to the main server by the assist server in replacement of the client; obtaining a computing processing result and feeding back the computing processing result to the assist server by the main server; and sending the computing processing result to the client by the assist server.

The information processing system and the method thereof in the present invention are described as above, and the difference between the present invention and the prior art lies in that, in the present invention, when monitoring that a network connecting speed between a main server and a client is too low, an assist server monitors all packets transmitted between the main server and the client, and after finding a packet that meets a takeover condition, the assist server requests, in replacement of the client, the main server to process the packet and finally returns a computing processing result fed back by the main server to the client, so as to achieve the technical efficacy of proactively assisting the main server to reduce the loading thereof.

### BRIEF DESCRIPTION OF THE DRAWINGS

FIG. 1 is a schematic diagram of elements of an information processing system according to the present invention.

FIG. 2 is a flow chart of an information processing method according to the present invention.

### DESCRIPTION OF THE EMBODIMENTS

Implementation manners of the present invention are illustrated in detail below with reference to accompanying drawings and embodiments, so the implementation procedure about how technical means is applied to the present invention to solve the technical problem and achieve the technical efficacy can be fully understood and implemented accordingly by persons skilled in the art.

The present invention may monitor packets between a main server and a client when a network connecting speed between the main server and the client is too low, so that the present invention may process the packet transmitted by the client in replacement of the main server when the main server is incapable of effectively processing a request of the client due to excessive loading, so as to reduce the loading of the main server and reduce the number of clients connected to the server and with excessive response time.

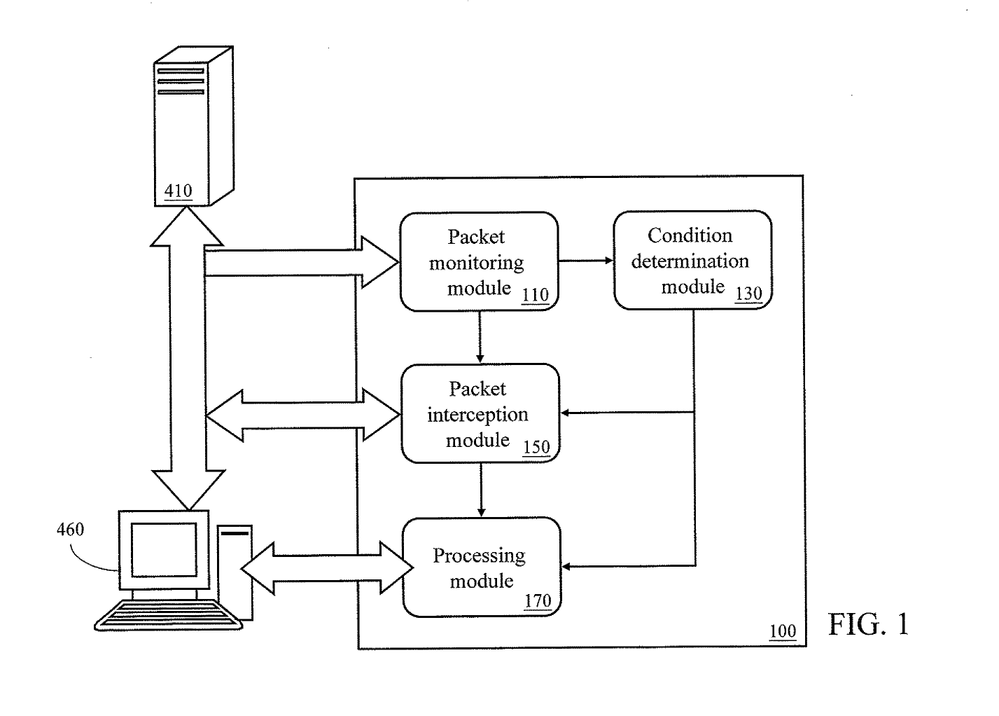

The implementation of the present invention is illustrated below with reference to FIG. 1, which is an architectural diagram of an information processing system according to the present invention. Referring to FIG. 1, an assist server 100 of the present invention includes a packet monitoring module 110, a condition determination module 130, a packet interception module 150, and a processing module 170.

The packet monitoring module 110 is used for monitoring a network connecting speed between a main server 410 and a client, and when the network connecting speed is lower than a predetermined network speed value, monitoring all packets transmitted between the main server 410 and the client. In the present invention, the number of clients may be one or more, and the implementation of the present invention is not affected by the number of clients. Therefore, the following description is directed to one client.

The condition determination module 130 is used for searching for a packet that meets a takeover condition from all packets monitored by the packet monitoring module 110, and acquiring the packet. The takeover condition based on which the condition determination module 130 makes determination includes: whether a packet monitored by the packet monitoring module 110 can be processed by the processing module 170, or whether response time of the client is higher than a predetermined value, and the like, but the present invention is not limited thereto. When the condition determination module 130 determines that the takeover condition is met by one or more packets, it indicates that the client transmitting the packet that meets the takeover condition is a target client 460.

The packet interception module 150 is used for communicating with the main server 410 and sending, in replacement of the target client 460, a processing request for all packets that meet the takeover condition to the main server 410 when the condition determination module 130 determines that the target client 460 exists, that is, the condition determination module 130 determines that there exists a packet transmitted by some client and meeting the takeover condition.

The processing module 170 is used for receiving a computing processing result fed back by the main server 410 and sending the received computing processing result to the target client 460.

The processing module 170 is also used for assisting the main server 410 to jointly process the packet transmitted by the client when the packet monitoring module 110 monitors that the network connecting speed is lower than a predetermined network speed value and a request from the main server 410 for jointly processing the packet transmitted by the client is received. However, in some embodiments, the processing module 170 may also reject a processing task from the main server 410, the processing task is transmitting the packet by the client.

The processing module 170 may also be used for communicating, in replacement of the client, with the main server 410 when the packet monitoring module 110 monitors that no packet is transmitted between the main server 410 and the client, recording a communication result with the main server 410, and when the packet monitoring module 110 monitors that packet transmission between the main server 410 and the client is recovered, that is, when a packet transmitted from the main server 410 to the client or from the client to the main server 410 is monitored again, sending the recorded communication result to the client.

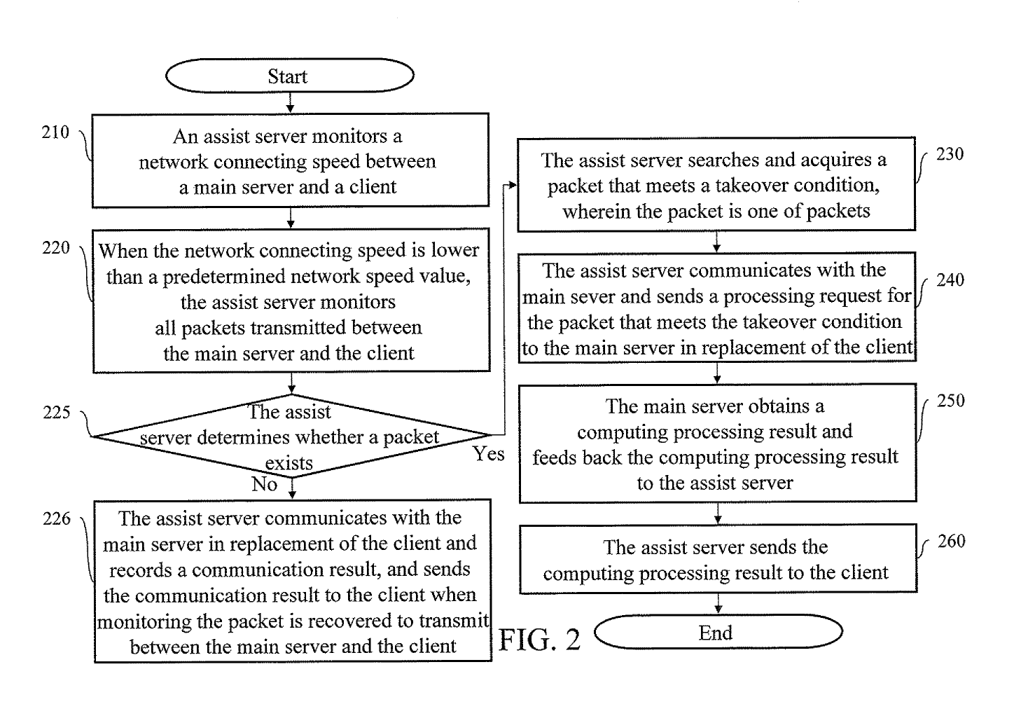

Subsequently, the operating system and method of the present invention are described with reference to an embodiment and FIG. 2. FIG. 2 is a flow chart of an information processing method according to the present invention.

First, a packet monitoring module 110 of an assist server 100 may monitor a network connecting speed between a main server 410 and a client (step 210). When the packet monitoring module 110 monitors that the network connecting speed is lower than a predetermined network speed value, the packet monitoring module 110 may monitor all packets transmitted between the main server 410 and the client (step 220).

After the packet monitoring module 110 of the assist server 100 monitors all packets transmitted between the main server 410 and the client (step 220), the packet monitoring module 110 may determine whether a packet between the client and the main server 410 is monitored (step 225).

If the packet monitoring module 110 of the assist server 100 does not monitor any packet between the client and the main server, the assist server 100 may communicate, in replacement of the client, with the main server 410. When the assist server 100 communicates, in replacement of the client, with the main server 410, the processing module 170 of the assist server 100 may record a communication result between the assist server 100 and the main server 410.

Then, when the packet monitoring module 110 of the assist server 100 monitors that packet transmission between the main server 410 and the client is recovered, the processing module 170 of the assist server 100 may send the communication result to the client at which the transmission is recovered.

Moreover, if the packet monitoring module 110 of the assist server 100 monitors that packets are transmitted between the client and the main server, the condition determination module 130 of the assist server 100 may search for a packet that meets a takeover condition from the monitored packets.

After the condition determination module 130 of the assist server 100 finds a packet that meets the takeover condition from the monitored packets and acquires the packet (step 230), the packet interception module 150 of the assist server 100 may communicate with the main server 410, so as to send, in replacement of the client, a processing request for all packets that meet the takeover condition to the main server 410 (step 240).

In this manner, when generating a computing processing result according to the received packet, the main server 410 may feed back the generated computing processing result to the assist server 100 (step 250). The processing module 170 of the assist server 100 may receive the computing processing result generated by the main server 410 and send the computing processing result to the client (step 260).

In the above embodiment, the main server 410 may also forward the packet transmitted by the client to the assist server 100 when it is monitored that the network connecting speed between the main server 410 and the client is lower than the predetermined network speed value, so that the processing module 170 of the assist server 10 assists processing the packet. However, the processing module 170 of the assist server 100 may also reject a processing task from the main server 410, wherein the processing task is transmitting the packet by the client.

In addition, the main server 410 may also send a request for assistance to the assist server 100 when it is monitored that the network connecting speed between the main server 410 and the client is lower than the predetermined network speed value. After receiving the request, the processing module 170 of the assist server 100 may jointly process, with the main server 410, the packet transmitted by the client.

To sum up, the difference between the present invention and the prior art lies in the following technical means: when monitoring that a network connecting speed between a main server and a client is too low, an assist server monitors packets transmitted between the main server and the client, and after finding a packet that meets a takeover condition, requests, in replacement of the client, the main server to process the packet, and finally returns a computing processing result fed back by the main server to the client, so as to achieve the technical efficacy of proactively assisting the main server actively to reduce the loading thereof. The technical means solves the problem in the prior art that a main server is incapable of effectively processing a request from a client due to excessive loading when a network connecting speed is too low, and further achieves the technical efficacy of proactively assisting the main server to reduce the loading thereof.

In addition, the method of monitoring packets so as to proactively assist a main server may be implemented through hardware, software, or a combination thereof, and may also be implemented in a computer system in an integrated manner, or implemented in different components distributed in several interconnected computer systems in a distributed manner.

What is claimed is:

1. An information processing method, applied to a server environment, the server environment at least comprises a main server and an assist server, and the main server connects to at least one client, comprising:
monitoring network connecting speed between the main server and the client by the assist server ;
monitoring by the assist server all packets transmitted between the main server and the client when the network connecting speed is lower than a predetermined network speed value;
searching and acquiring by the assist server at least one packet which meets takeover condition, wherein the packet is one of the all packets transmitted between the main server and the client;
communicating with the main server and sending a processing request for the packet which meets takeover condition to the main server by the assist server in replacement of the client;
obtaining a computing processing result and feeding back the computing processing result to the assist server by the main server; and
sending the computing processing result to the client by the assist server.

2. The information processing method according to claim 1, wherein when the assist server monitors that no packet is transmitted between the main server and the client, the assist server communicates with the main server in replacement of the client and records a communication result; when monitoring the packet is recovered to transmit between the main server and the client, the assist server sends the communication result to the client.

3. The information processing method according to claim 1, wherein when the network connecting speed is lower than the predetermined network speed value, the main server sends a packet which transmitted by the client to the assist server to process.

4. The information processing method according to claim 3, after the main server sending the packet transmitted by the client to the assist server for processing, further comprising: the assist server rejects a processing task from the main server which the processing task is transmitting the packet by the client.

5. The information processing method according to claim 1, wherein when the network connecting speed is lower than the predetermined network speed value, the main server requests the assist server to jointly process the packet transmitted by the client.

6. An information processing system, at least comprising:
a main server, connecting to at least one client, and used for receiving a request and obtaining a computing processing result; and
an assist server, further comprising:
a packet monitoring module, used for monitoring network connecting speed between the main server and the client, when the network connecting speed is lower than a predetermined network speed value, further monitoring all packets transmitted between the main server and the clients;
a condition determination module, used for searching and acquiring at least one packet which meets takeover condition, the packet is one of the all packets transmitted between the main server and the client;
a packet interception module, used for communicating and sending to the main server in replacement of the client, a processing request for the packet which meets takeover condition to the main server; and
a processing module, used for receiving the computing processing result fed back by the main server and sending the computing processing result to the client.

7. The information processing system according to claim 6, wherein when the assist server monitors that no packet is transmitted between the main server and the client, the assist server communicates with the main server in replacement of the client and records a communication result; when the assist server monitors that the packet is recovered to transmit between the main server and the client, the assist server sends the communication result to the client.

8. The information processing system according to claim 6, wherein the main server is further used for sending the packet which is transmitted by the client to the assist server to process when the network connecting speed is lower than the predetermined network speed value.

9. The information processing system according to claim 8, wherein the assist server is further used for rejecting a process task from the main server which the process task is transmitting the packet by the client.

10. The information processing system according to claim 6, wherein the main server is further used for requesting the assist server to jointly process the packet transmitted by the client when the network connecting speed is lower than the predetermined network speed value.
